(19) United States
(12) Patent Application Publication
(10) Pub. No.: US 2024/0324523 A1
(43) Pub. Date: Oct. 3, 2024

(54) MODULAR SYSTEM FOR CREATING FLORAL SCENIC DESIGNS

(71) Applicant: BA.MA. S.P.A., Altopascio (IT)

(72) Inventor: Rossella BAIOCCHI, Altopascio (IT)

(21) Appl. No.: 18/585,228

(22) Filed: Feb. 23, 2024

(30) Foreign Application Priority Data
Mar. 29, 2023 (IT) 102023000006030
Dec. 19, 2023 (IT) 102023000027210

(51) Int. Cl. A01G 9/02

(52) U.S. Cl. CPC A01G 9/025

(57) ABSTRACT

The modular system comprises a plurality of panels with a front face, a rear face and a perimeter edge. Each panel comprises mutual constraint devices between adjacent panels along the perimeter edge. The system further comprises a plurality of containers for plants, each constrained or which can be constrained to a respective panel.

### TECHNICAL FIELD

The present invention relates to systems for making compositions of ornamental plants or the like, for example for creating floral scenic designs of various types, even for advertising.

### BACKGROUND ART

The use of compositions of plants, for example flower plants or ornamental plants in general, to obtain particular esthetic effects, is known. These compositions can be very complex to create, and they require specialized labor.

The difficulty in creating complex compositions consisting of ornamental plants increases as such compositions are constructed on non-horizontal surfaces, i.e. inclined with respect to the horizontal, some times even on approximately vertical surfaces.

Therefore, it would be advantageous to have a system that facilitates the creation of these compositions.

### SUMMARY

According to the invention, a modular system is provided for creating floral scenic designs, which comprises: a plurality of panels with a front face, a rear face and a perimeter edge; wherein along the perimeter edge each panel comprises mutual constraint devices between adjacent panels; and a plurality of containers for plants, each constrained or which can be constrained to a respective panel.

As will be clear from the detailed description that follows of one embodiment, a plurality of modules each comprising a panel and a container, can be assembled with each other to obtain complex decorative structures or compositions, for example even for forming letters and full words by assembling several modules in an appropriate arrangement on a carrying surface.

The modular system according to the present invention may also comprise further elements, in addition to the panels and containers described herein and it may also use panels without containers, for example for obtaining structural connections.

Theoretically, the single module of the modular system may be configured as a single block comprising the panel and the container. However, preferably, each container consists of a component physically separated from the respective panel and it can be connected thereto using mutual connection devices between container and panel. This simplifies the production, in particular when carried out by molding plastic material, i.e. polymeric material. Furthermore, the containers and the panels, separate from each other, may be packaged easily and in little space, thus simplifying transportation and display at the points of sale, with resulting cost effectiveness. Also the assembly of the modules and the maintenance of the compositions thus obtained are facilitated by the creation of modules with separate panels and containers. For example, this allows the replacement of single containers with others, without removing the contents thereof on site.

The containers are advantageously used for housing ornamental plants therein. The possibility of detaching and attaching containers to a composition of panels which is not modified allows to install, remove, and replace the plants of a composition quickly, placing the plants in the containers in an appropriate place, for example in a tree nursery, instead of in the place where the composition formed with the combination of modules is installed.

Advantageous additional features of specific embodiments of the modular system according to the invention are described below and set forth in the attached claims.

Forming an object of the invention is also a composition obtained with the combination of modules as defined above, in which the single containers contain ornamental plants, for example. In particular, the compositions may in turn consist of one or more letters or full words written by assembling a plurality of single modules into appropriate combinations. Advantageously, the compositions may be supported on walls or on surfaces which are inclined with respect to the horizontal, advantageously on surfaces or structures that are vertical, or steeply inclined with respect to the horizontal, typically by 450 or more, on which compositions of ornamental plants are complex and expensive to assemble.

In the present description, the expressions “frontal”, “back”, “front”, “rear”, “upper”, “lower” and the like respectively refer to the respective element or component as arranged when in use, i.e. when forming the composite installation of modules of the modular system.

In the present context, vertical means a direction parallel to the direction of the force of gravity and horizontal meawns a direction orthogonal to the vertical direction.

### BRIEF DESCRIPTION OF THE DRAWINGS

The invention will be clearer from the description and the attached drawings, which illustrate an embodiment provided by way of non-limiting example of the invention. More particularly, in the drawings:

FIG. 1 is a front axonometric view of a module of the modular system, the module comprising a panel and a respective container, in a disassembled configuration;

FIG. 2 is a rear axonometric view of the module of FIG. 1;

FIG. 3 is a front axonometric view of the module of FIGS. 1 and 2 in an assembled configuration;

FIG. 4 is a rear axonometric view of the module of FIGS. 1 and 2 in an assembled configuration;

FIG. 5 is a front view of an assembly of modules assembled to each other;

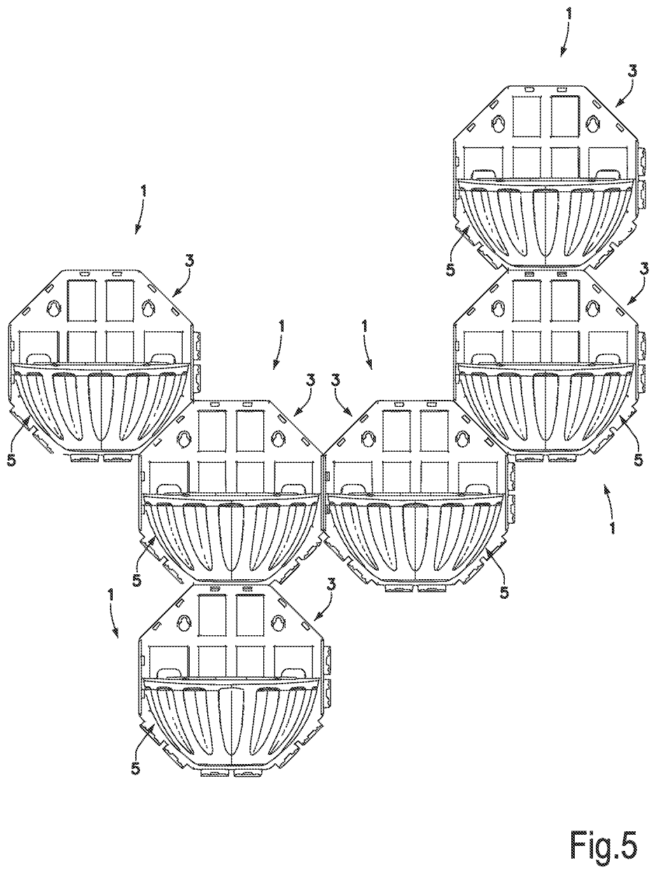

FIG. 6 is a front axonometric view of the assembly of FIG. 5;

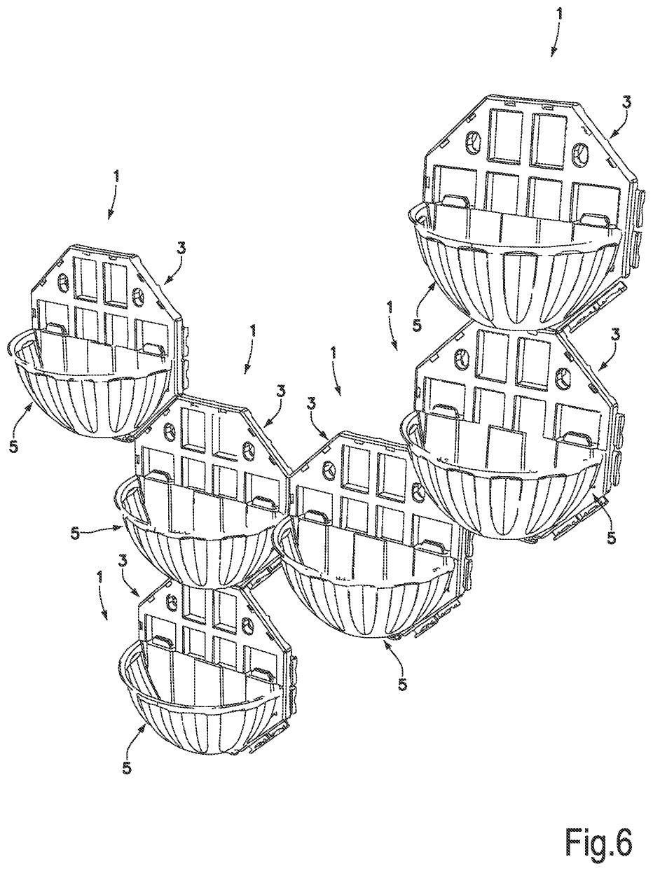

FIG. 7 is a front axonometric view of two panels of two modules separate from each other;

FIG. 8 is a front axonometric view of two panels of two modules separate from each other;

FIG. 9 is a view similar to FIG. 8 with the two panels assembled to each other;

FIG. 10 is a view similar to FIG. 7 with the two panels assembled to each other; and

FIG. 11 is a representation of the letters of the alphabet which can be obtained through compositions of single modules of the modular system of the present invention.

### DETAILED DESCRIPTION

The modular system of the present invention consists of a plurality of modules, each of which in turn consists of two elements, hereinafter referred to as panel and container. In the embodiment described herein, the panel and the container of each module consist of two physically separate units.

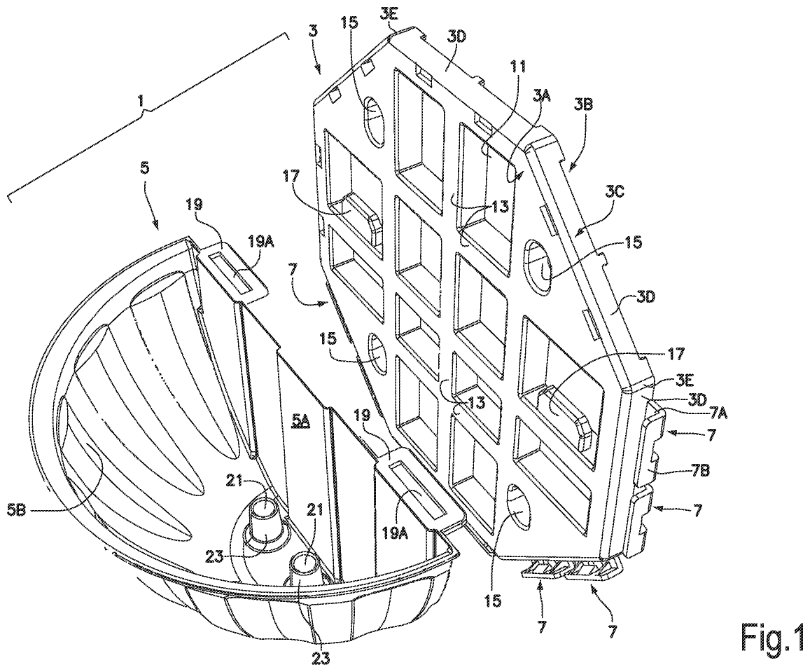

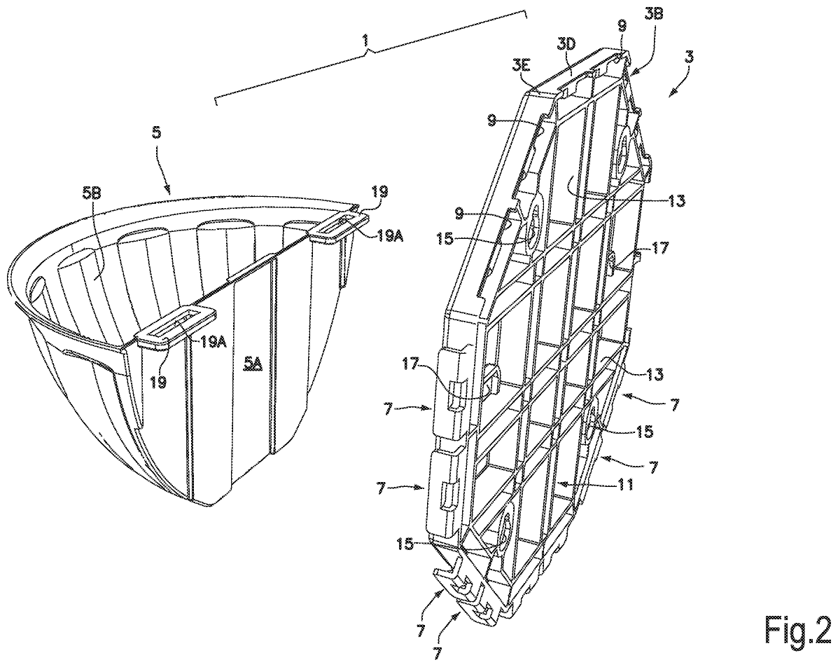

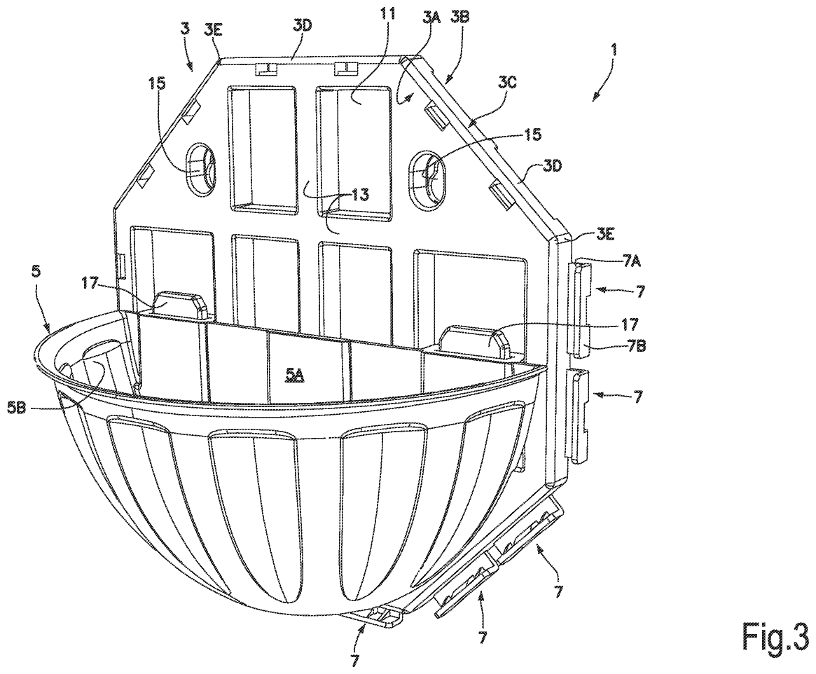

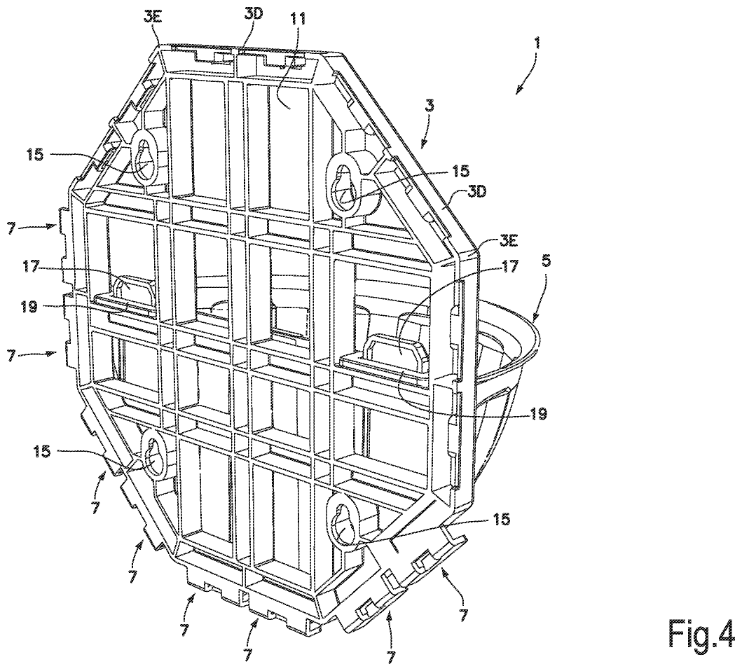

The single module of the modular system is shown in a front and rear axonometric view in a disassembled configuration in FIGS. 1 and 2 and in assembled configuration in FIGS. 3 and 4.

The modular system in the described embodiment comprises modules all of which are equal to each other; however the possibility of adding modules of another shape or size, for example, to expand the range of possible compositions that can be obtained with the modular system, is not excluded.

The single module of the modular system is labeled 1. It comprises a panel 3 and a container 5. The panel 3 comprises a front or frontal face 3A and a rear or back face 3B. The panel 3 comprises a perimeter edge 3C.

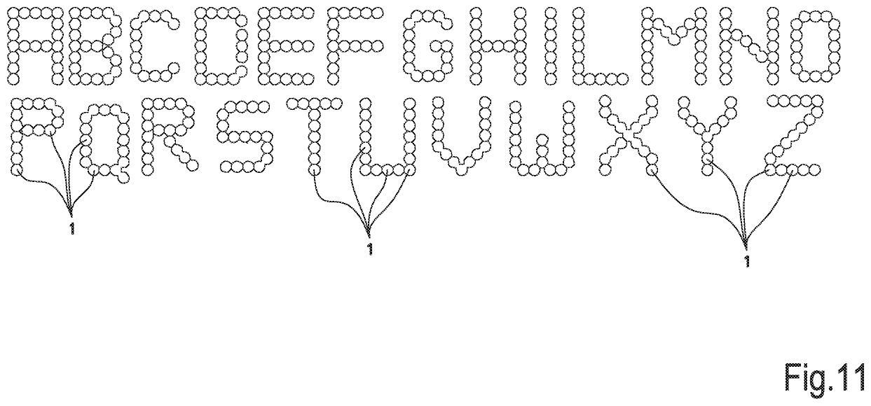

In the illustrated embodiment, the panel 3 is polygonal-shaped and more precisely in the shape of a regular octagonal, so as to allow several modules 1 to be placed one adjacent to the other in various arrangements so that they can form in combination all the letters of the alphabet, as schematically shown in FIG. 11.

In the illustrated embodiment, the perimeter edge 3C consists of eight straight sides 3D, connected to each other along the edges or corners 3E.

The single panels 3 comprise mutual constraint devices between adjacent panels, to allow to join said panels and form a composition which may reproduce a letter of the alphabet, for example.

In the illustrated embodiment, the mutual constraint devices are formed along the perimeter edges 3C of the single panels 3. In the illustrated embodiment, the mutual constraint devices comprise hook-shaped male coupling elements 7 and slot or recess-shaped female coupling elements 9 (FIG. 2). Advantageously, the male coupling elements 7 protrude from a plurality of straight sides 3D of the panel 3 and they may for example extend from the rear or back face 3B of the panel with a portion 7A towards the external of the perimeter edge and be shaped to form a hook 7B protruding toward the front or frontal face 3A of the panel, as shown in particular on the right bottom part of FIG. 1. The male coupling elements 7 advantageously have a size in the direction orthogonal to the front 3A and rear 3B face of the panel 3, which is smaller than the thickness of the panel 3, i.e. smaller than the distance between the two faces 3A, 3B.

The slots or recesses 9 forming the female coupling elements are visible on the rear face (FIG. 2) of the panel 3 and are arranged along the straight edges 3D.

More particularly, half of the edges 3D of each panel 3 are provided with male coupling elements 7 and at least the other half of the edges 3D of each panel 3 are provided with female coupling elements 9. Preferably, the male coupling elements 7 are arranged along four consecutive edges 3D.

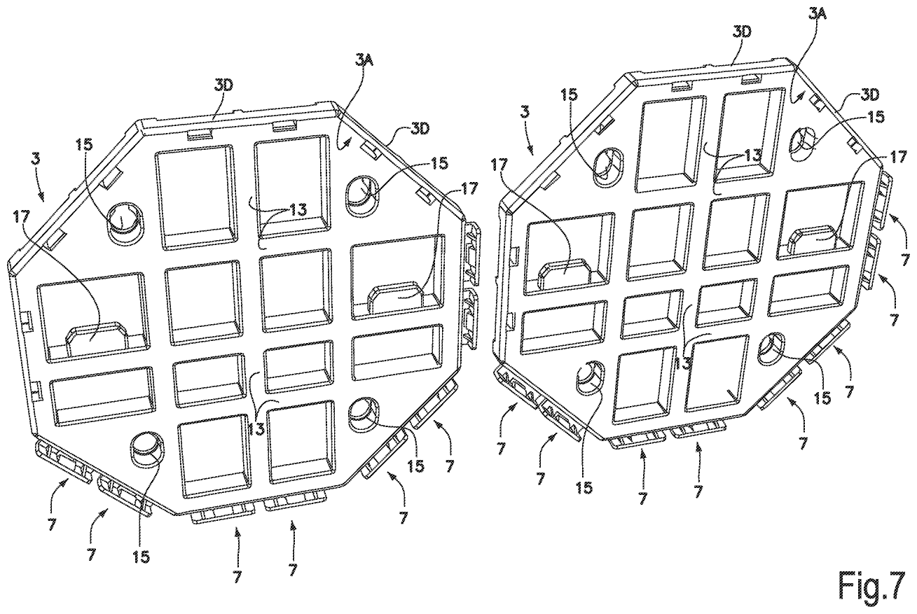

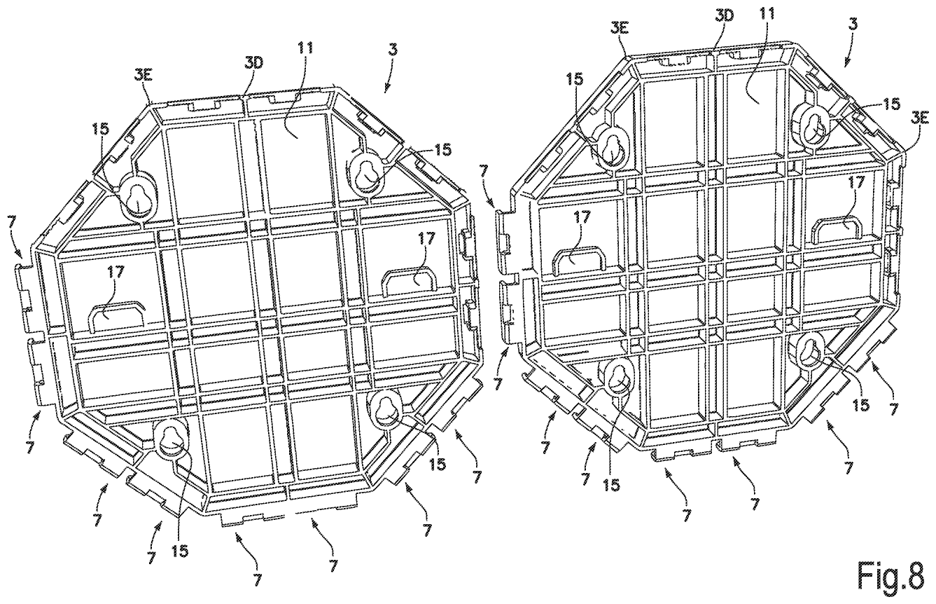

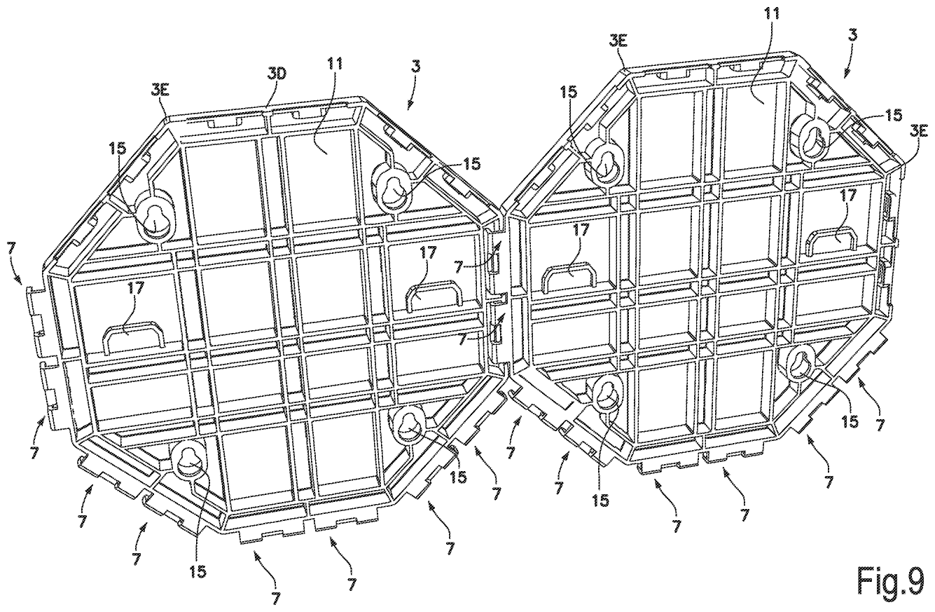

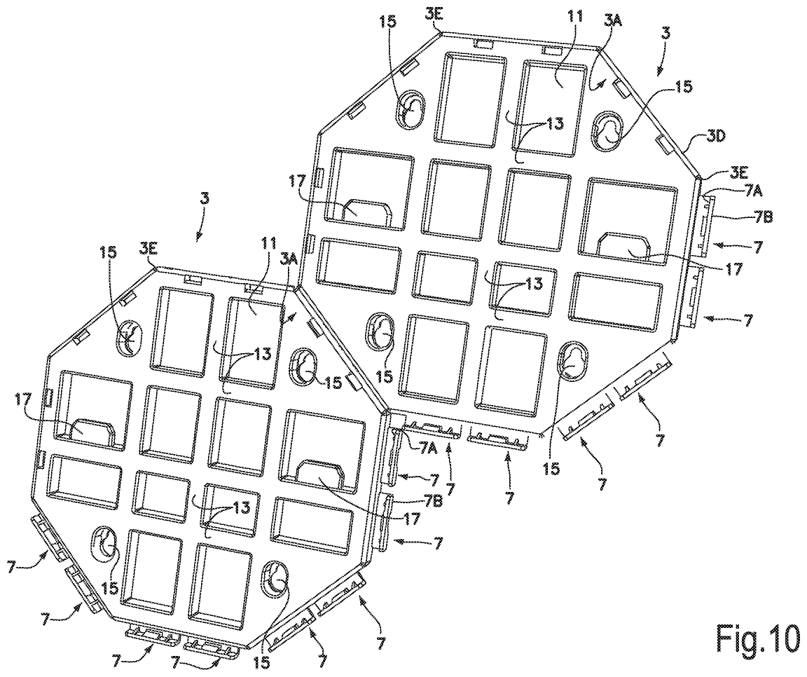

The mutual connection between the two panels 3 placed next to each other is obtained by inserting the male coupling elements 7 of an edge 3D of a first panel 3 into the recesses 9 along an edge 3D of the second panel 3, as shown in particular in FIGS. 7, 8, 9 and 10.

Each panel 3 with the respective male coupling elements 7 and female coupling elements 9 is preferably made of polymeric material and manufactured by molding.

In order to lighten the structure and reduce deformations caused by shrinkage of the molded pieces, each panel 3 advantageously comprises a lattice structure with windows 11 delimited by a lattice 13. The windows 11 form meshes of the lattice structure 13. The lattice 13 may in turn consist of hollow straight elements, for example with a C-shaped section, as shown in FIG. 2. The lattice structure may also be used to facilitate the growth and fixing of climbing plants along a composition of several modules combined with each other.

In the illustrated embodiment, each panel 3 comprises members for fixing to a load-bearing structure (not shown). For example, the fixing members may comprise one or more through holes 15, within which there may extend hooks or screws, for example, which can be screwed to expansion plugs inserted into the load-bearing structure. The latter may consist of a wall, a fence, or any other static artefact preferably with vertical or approximately vertical extension, having a surface on which the desired number of modules 1 can be arranged.

In the illustrated embodiment, to simplify production, transportation, and assembly, the container 5 of each module 1 is formed as a component or body that is separate from the panel 3. To connect the container 5 stably but reversibly to the respective panel 3 special connection devices are provided. To enable an assembly and a possible quick disassembly without having to use tools or equipment, in the embodiments illustrated herein, the connection devices between the panel 3 and the container 5 are interlocking devices.

For example, the interlocking devices may have male and female elements. In the illustrated embodiment, the connection devices between the panel 3 and the container 5 comprise two male elements and two corresponding female elements. In other embodiments, the number of the male and female elements may be different, for example a single male element and a single female element may be sufficient.

In embodiments, the male elements of the connection device are formed on the panel 3 and the female elements of the connection device are formed in the container 5. As visible in particular in FIGS. 1, 2, 3 and 4, each panel 3 comprises two male elements 17 which can be housed in respective meshes 11 of the lattice structure 13. Each container 5 comprises two female elements 19, for example in form of eyelets, along an upper edge of the container 5 and more specifically for example along a straight section of the upper edge, delimiting a substantially flat face 5A of the container 5, which will rest on the front or frontal face 3A of the respective panel in the assembled configuration. In the illustrated embodiment, the container has a quarter sphere shape, with a second face 5B in the shape of a spherical surface portion. The possibility of providing the container 5 made of a different shape, for example parallelepiped or cube-shaped, cannot be ruled out.

To produce a panel 3 with small thickness, the male elements 17 are flat-shaped, to remain within the thickness of the lattice structure 11. Correspondingly, the eyelets 19 have rectangular openings 19A, extended in the direction of the edge of the container 5.

The faces 5A, 5B are approximately respectively flat and spherical, given that they advantageously have reinforcement ribs which make the structure stiffer and less deformable.

In the illustrated embodiment, each container 5 has lower openings 21 for discharging rain or irrigation water. The openings 21 may be formed in the upper part of truncated cone structures 23 protruding from the bottom of the container 5 upwards, that is towards the mouth of the container 5, delimited by the upper edge thereof, along which the eyelets 19 are formed.

Also the containers 5 may be manufactured by molding polymeric material.

The modules 1 may be arranged adjacent to each other and connected through elements 7 and 9 along respective sides 3D of the perimeter edges 3C arranged adjacent to each other. The panels 3 have an octagonal shape which allows arranging the two panels 3 adjacent to each other in eight different positions thus obtaining all the letters of the alphabet through a suitable combination and arrangement of a sufficient number of modules 1. FIG. 11 schematically shows how to obtain all the letters of the alphabet using the modules 1.

Therefore, by arranging an appropriately-sized load-bearing structure, one can form writings formed by several letters sequentially. Each container 5 of the various modules 1 assembled to form the desired writing may be filled with ornamental plants and form a decorative structure with great esthetic effect.

In other embodiments, the panels 3 may have a non-octagonal edge, but however provided with mutual constraint devices between adjacent panels positioned according to an octagonal arrangement, preferably a regular octagonal arrangement. For example, each panel 3 may have a circular edge with constraint devices arranged in eight equally spaced positions along the circumference of the edge, to basically form eight constraint points with adjacent panels. The constraint points are arranged according to an octagonal, preferably regular, arrangement. In this case, the octagon forming the edge of the modular panels 3 does not directly consist of the physical edge of the panel, but of the position of the mutual constraint devices.

Also in this case, the preferably regular, octagonal arrangement of the mutual constraint devices between adjacent panels 3 enables to obtain alpha-numerical writings by combining the panels with each other.

What is claimed is:

1. A modular system for creating floral scenic designs, the system comprising:
a plurality of panels with a front face, a rear face and a perimeter edge; wherein each panel comprises mutual constraint devices between adjacent panels along the perimeter edge; and
a plurality of containers for plants, each constrained to, or which can be constrained to a respective panel;
wherein the mutual constraint devices between adjacent panels are positioned according to an octagonal arrangement.

2. The modular system of claim 1, wherein at least some of said panels comprise a lattice structure.

3. The modular system of claim 1, wherein each container consists of a component physically separated from the respective panel and connectable thereto using mutual connection devices between container and panel.

4. The modular system of claim 3, wherein the mutual connection devices between each panel and the respective container comprise mutually couplable male and female elements.

5. The modular system of claim 4, wherein the connection devices comprise male elements on the panel and female elements on the container.

6. The modular system of claim 5, wherein the male elements are housed in respective windows obtained in the panel, and wherein—in assembled configuration—the female elements on the container are housed in said windows.

7. The modular system of claim 1, wherein the constraint devices are arranged along the perimeter edge of each panel.

8. The modular system of claim 1, wherein the panels are octagonal and the respective perimeter edge of each panel comprises a plurality of straight sides consecutive with respect to each other, with which there are associated mutual constraint devices.

9. The modular system of claim 8, wherein said panels are regular octagonal.

10. The modular system of claim 1, wherein the constraint devices comprise male coupling elements and female coupling elements complementary to each other and which can be mutually connected; and wherein along a first half of the perimeter edge of each panel male coupling elements are arranged and along a second half of the perimeter edge of each panel female coupling elements are arranged.

11. The modular system of claim 10, wherein the male coupling elements comprise hooks protruding from the perimeter edge and contained in the thickness of the respective panel; and wherein the female coupling elements comprise recesses along the perimeter edge and therein.

12. The modular system of claim 11, wherein the recesses are arranged on a rear face of the respective panel and the hooks protrude from the rear surface of the panel toward the external of the perimeter edge and toward the front face of the panel.

13. The modular system of claim 1, wherein each panel comprises fixing members for fixing to a load-bearing structure.

14. The modular system of claim 13, wherein the fixing members comprise through holes for each coupling member.

15. The modular system according to claim 1, wherein the containers comprise lower openings for discharging irrigation water.

16. A composition of containers for plants, comprising a plurality of panels connected to each other, to at least some of which respective containers are constrained; wherein each panel comprises a front face, a rear face and a perimeter edge; wherein each panel comprises mutual constraint devices between adjacent panels along the perimeter edge; and wherein the mutual constraint devices between adjacent panels are positioned according to an octagonal arrangement.

17. The composition of claim 16, wherein the panels are applied to an approximately vertical load-bearing structure.
